(19) United States
(12) Patent Application Publication
(10) Pub. No.: US 2021/0109674 A1
(43) Pub. Date: Apr. 15, 2021

(54) MEMORY COMMAND QUEUE MANAGEMENT

(71) Applicant: QUALCOMM Incorporated, San Diego, CA (US)

(72) Inventors: Madhu Yashwanth BOENAPALLI, Hyderabad (IN); Surendra PARAVADA, Hyderabad (IN); Venu Madhav MOKKAPATI, Hyderabad (IN); Sai Praneeth SREERAM, Anantapur (IN)

(21) Appl. No.: 16/653,931

(22) Filed: Oct. 15, 2019

(51) Int. Cl. G06F 3/06

(52) U.S. Cl. CPC G06F 3/0659; G06F 3/0635; G06F 3/0656; G06F 3/0653; G06F 3/0613; G06F 3/0625; G06F 3/0679

(57) ABSTRACT

In some aspects, the present disclosure provides a method for managing memory commands from a plurality of masters. The method includes receiving, at a storage driver, a plurality of memory commands from the plurality of masters and determining, by the storage driver, a number of command queues of a plurality of command queues to use to service the plurality of memory commands. In certain aspects, the method includes routing, via one or more of a plurality of lanes, the plurality of memory commands to a storage controller according to the determined number of command queues, wherein each of the plurality of lanes corresponds to one of the plurality of command queues and storing, by the storage controller, one or more of the plurality of memory commands in each of the determined number of command queues.

### BACKGROUND

### Field of the Disclosure

The teachings of the present disclosure relate generally to memory operations, and more particularly, to techniques for command queue management in a memory, such as a universal flash storage (UFS) host device.

### Description of the Related Art

Flash memory (e.g., non-volatile computer storage medium) is a type of memory that can store and hold data without a constant source of power. In contrast, data stored in volatile memory may be erased if power to the memory is lost. Flash memory is a type of non-volatile memory that has become popular in many applications. For example, flash memory devices are used in many communication devices, automobiles, cameras, etc. In some cases, flash memories are required to support a relatively large number of subsystems in a single device. Such subsystems may include a camera, a display, location services, user applications, etc.

However, as the applications for flash memory expand, so too do the number of subsystems that rely on the flash memory. Managing a relatively large number of subsystems that require simultaneous execution of memory commands may pose challenges.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Certain aspects relate to a method for managing memory commands from a plurality of masters. In some examples, the method comprises receiving, at a storage driver, a plurality of memory commands from the plurality of masters. In some examples, the method comprises determining, by the storage driver, a number of command queues of a plurality of command queues to use to service the plurality of memory commands. In some examples, the method comprises routing, via one or more of a plurality of lanes, the plurality of memory commands to a storage controller according to the determined number of command queues, wherein each of the plurality of lanes corresponds to one of the plurality of command queues. In some examples, the method comprises storing, by the storage controller, one or more of the plurality of memory commands in each of the determined number of command queues. In some examples, the method comprises serving, by the storage controller, the plurality of memory commands to a memory device.

Certain aspects relate to an apparatus configured to manage memory commands from a plurality of masters, comprising a memory and a processor communicatively coupled to the memory, wherein the processor is configured to determine, by the storage driver, a number of command queues of a plurality of command queues to use to service the plurality of memory commands. In some examples, the processor is configured to route, via one or more of a plurality of lanes, the plurality of memory commands to a storage controller according to the determined number of command queues, wherein each of the plurality of lanes corresponds to one of the plurality of command queues. In some examples, the processor is configured to store, by the storage controller, one or more of the plurality of memory commands in each of the determined number of command queues. In some examples, the processor is configured to serve, by the storage controller, the plurality of memory commands to a memory device.

Certain aspects relate to non-transitory computer readable storage medium that stores instructions that when executed by a processor of an apparatus cause the apparatus to perform a method of manage memory commands from a plurality of masters, comprising receiving, at a storage driver, a plurality of memory commands from the plurality of masters. In some examples, the method comprises determining, by the storage driver, a number of command queues of a plurality of command queues to use to service the plurality of memory commands. In some examples, the method comprises routing, via one or more of a plurality of lanes, the plurality of memory commands to a storage controller according to the determined number of command queues, wherein each of the plurality of lanes corresponds to one of the plurality of command queues. In some examples, the method comprises storing, by the storage controller, one or more of the plurality of memory commands in each of the determined number of command queues. In some examples, the method comprises serving, by the storage controller, the plurality of memory commands to a memory device.

Aspects of the present disclosure provide means for, apparatus, processors, and computer-readable mediums for performing techniques and methods for managing memory commands at a memory, such as a UFS host device.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram illustrating an exemplary system-on-chip (SoC) integrated circuit in accordance with certain aspects of the present disclosure.

FIG. 2A is block diagram illustrating an exemplary system including an SoC circuit coupled with a universal flash storage (UFS) device in accordance with certain aspects of the present disclosure.

FIG. 2B is block diagram illustrating an exemplary system including an SoC circuit coupled with a universal flash storage (UFS) device in accordance with certain aspects of the present disclosure.

FIG. 3 is a flow diagram illustrating an example process for command queue management in accordance with certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with various other embodiments discussed herein.

The term “system on chip” (SoC) is used herein to refer to a single integrated circuit (IC) chip that contains multiple resources and/or processors integrated on a single substrate. A single SoC may contain circuitry for digital, analog, mixed-signal, and radio-frequency functions. A single SoC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.), any or all of which may be included in one or more cores.

A number of different types of memories and memory technologies are available or contemplated in the future, all of which are suitable for use with the various aspects of the present disclosure. Such memory technologies/types include phase change memory (PRAM), dynamic random-access memory (DRAM), static random-access memory (SRAM), non-volatile random-access memory (NVRAM), flash memory (e.g., embedded multimedia card (eMMC) flash, flash erasable programmable read only memory (FEPROM)), pseudostatic random-access memory (PSRAM), double data rate synchronous dynamic random-access memory (DDR SDRAM), and other random-access memory (RAM) and read-only memory (ROM) technologies known in the art. A DDR SDRAM memory may be a DDR type 1 SDRAM memory, DDR type 2 SDRAM memory, DDR type 3 SDRAM memory, or a DDR type 4 SDRAM memory.

Each of the above-mentioned memory technologies include, for example, elements suitable for storing instructions, programs, control signals, and/or data for use in or by a computer or other digital electronic device. Any references to terminology and/or technical details related to an individual type of memory, interface, standard or memory technology are for illustrative purposes only, and not intended to limit the scope of the claims to a particular memory system or technology unless specifically recited in the claim language. Mobile computing device architectures have grown in complexity, and now commonly include multiple processor cores, SoCs, co-processors, functional modules including dedicated processors (e.g., communication modem chips, global positioning system (GPS) processors, display processors, etc.), complex memory systems, intricate electrical interconnections (e.g., buses and/or fabrics), and numerous other resources that execute complex and power intensive software applications (e.g., video streaming applications, etc.).

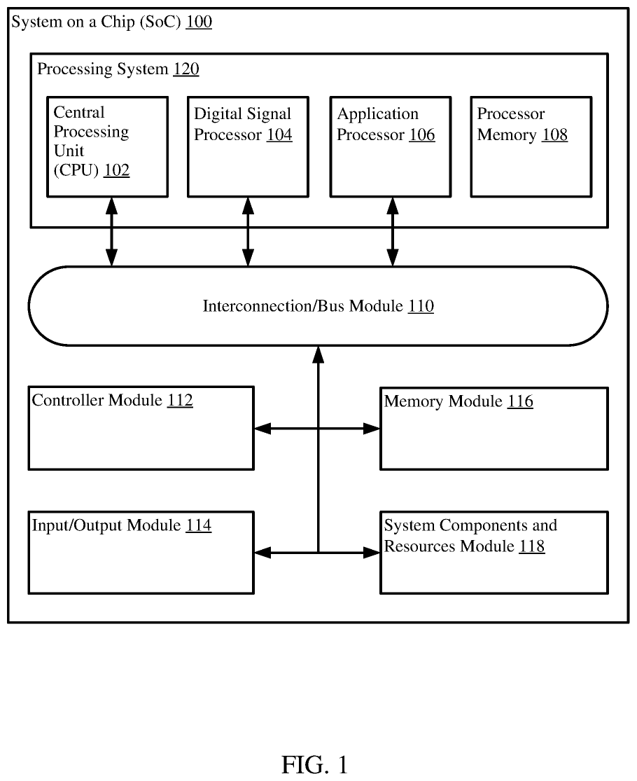

FIG. 1 is a block diagram illustrating an exemplary system-on-chip (SoC) 100 suitable for implementing various aspects of the present disclosure. The SoC 100 includes a processing system 120 that includes a plurality of heterogeneous processors such as a central processing unit (CPU) 102, a digital signal processor 104, an application processor 106, and a processor memory 108. The processing system 120 may include one or more cores, and each processor/core may perform operations independent of the other processors/cores. The processors 102, 104, and 106 may be organized in close proximity to one another (e.g., on a single substrate, die, integrated chip, etc.) so that they may operate at a much higher frequency/clock-rate than would be possible if the signals were to travel off-chip. The proximity of the cores may also allow for the sharing of on-chip memory and resources (e.g., voltage rail), as well as for more coordinated cooperation between cores.

The processing system 120 is interconnected with one or more controller module(s) 112, input/output (I/O) module(s) 114, memory module(s) 116, and system component and resources module(s) 118 via a bus module 110 which may include an array of reconfigurable logic gates and/or implement bus architecture (e.g., CoreConnect, advanced microcontroller bus architecture (AMBA), etc.). Bus module 110 communications may be provided by advanced interconnects, such as high performance networks on chip (NoCs). The interconnection/bus module 110 may include or provide a bus mastering system configured to grant SoC components (e.g., processors, peripherals, etc.) exclusive control of the bus (e.g., to transfer data in burst mode, block transfer mode, etc.) for a set duration, number of operations, number of bytes, etc.

The controller module 112 may be a specialized hardware module configured to manage the flow of data to and from the memory module 116, the processor memory 108, or a memory device located off-chip (e.g., a flash memory device). In some examples, the memory module 116 may include a UFS host device configured to receive various memory commands from multiple masters, and address and communicate the memory commands to a memory device. The multiple masters may include processors 102, 104, and 106, multiple applications running on one or more of the processors 102, 104, and 106, and/or modules such as the I/O module 114 or the system components and resources module 118. The controller module 112 may comprise one or more processors configured to perform operations disclosed herein. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

The I/O module 114 is configured for communicating with resources external to the SoC. For example, the I/O module 114 includes an input/output interface (e.g., a bus architecture or interconnect) or a hardware design for performing specific functions (e.g., a memory, a wireless device, and a digital signal processor). In some examples, the I/O module includes circuitry to interface with peripheral devices, such as a memory device located off-chip.

The memory module 116 is a computer-readable storage medium implemented in the SoC 100. The memory module 116 may provide non-volatile storage, such as flash memory, for one or more of the processing system 120, controller module 112, I/O module 114, and/or the system components and resources module 118. The memory module 116 may include a cache memory to provide temporary storage of information to enhance processing speed of the SoC 100. In some examples, the memory module 116 may be implemented as a universal flash storage (UFS) integrated into the SoC 100, or an external UFS card.

The SoC 100 may include a system components and resources module 118 for managing sensor data, analog-to-digital conversions, wireless data transmissions, and for performing other specialized operations (e.g., supporting interoperability between different devices). System components and resources module 118 may also include components such as voltage regulators, oscillators, phase-locked loops, peripheral bridges, data controllers, system controllers, access ports, timers, and other similar components used to support the processors and software clients running on the computing device. The system components and resources 118 may also include circuitry for interfacing with peripheral devices, such as cameras, electronic displays, wireless communication devices, external memory chips, etc.

In certain aspects, a memory module, such as a UFS host device, (e.g., memory module 116) may serve multiple masters (e.g., one or more processors of the processing system 120 and/or applications running thereon) by receiving memory commands from the multiple masters and serving the commands to a memory device. However, in some cases, several masters may compete for memory access at the same time, resulting in a congested queue of memory commands waiting to be executed. Similarly, a single master may be operating at a high rate, requiring the UFS host device to service many memory commands within a short period of time. Other parameters, such as battery life, processor speeds, number of applications executing simultaneously, etc., may also affect performance of the UFS host device. Thus, there is a need to effectively manage memory commands at the host device in order to improve efficiency of the SoC. Though certain aspects are described herein with respect to a UFS host device, it should be noted that such aspects may similarly apply to other suitable memory modules.

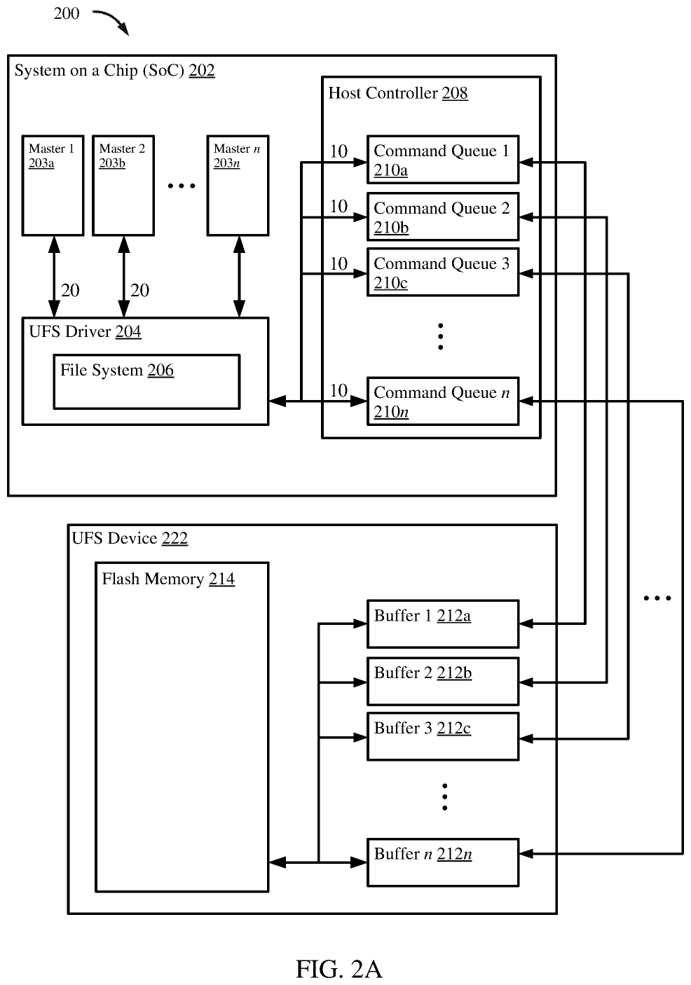

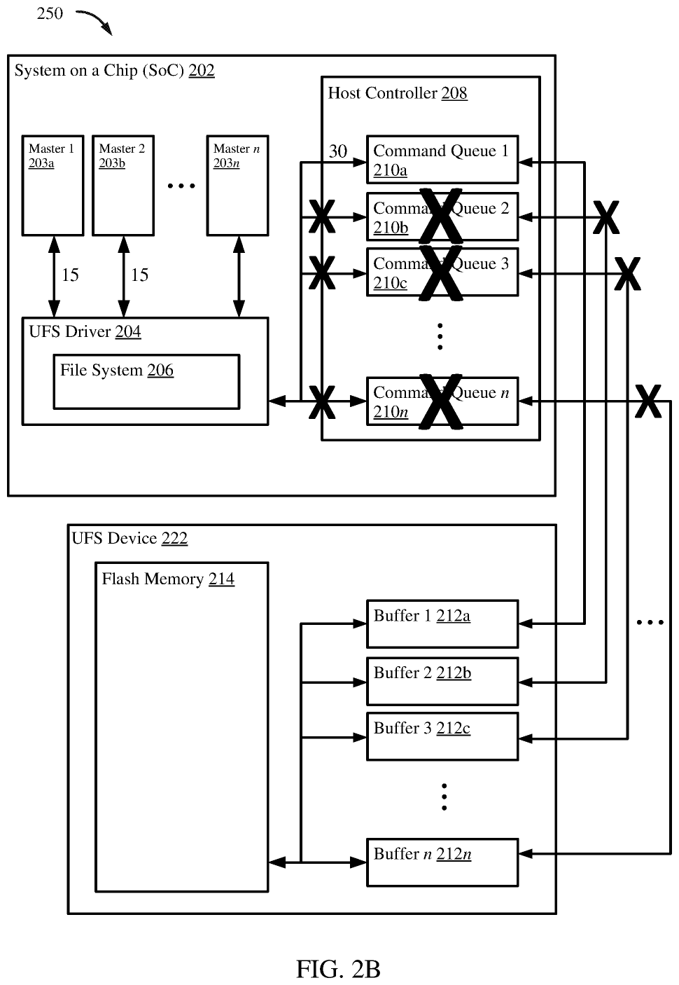

FIG. 2A is block diagram illustrating an exemplary memory system 200 including an SoC 202 (e.g., SoC 100) and a UFS device 222 (e.g., memory module 116 of FIG. 1) in accordance with certain aspects of the present disclosure. UFS device 222 may be an internal storage drive, such as a notebook hard drive or a desktop hard drive. UFS device 222 may be a removable mass storage device, such as, but not limited to, a handheld, removable memory device, such as a memory card (e.g., a secure digital (SD) card, a micro secure digital (micro-SD) card, or a multimedia card (MMC)) or a universal serial bus (USB) device. UFS device 222 may take the form of an embedded mass storage device, such as an eSD/eMMC embedded flash drive, integrated with the SoC 202. UFS device 222 may also be any other type of internal storage device, removable storage device, embedded storage device, external storage device, or network storage device.

As shown in FIG. 2A, the SoC 202 includes a plurality of masters 203a-n (e.g., one or more of the processors 102, 104, 106 and modules of FIG. 1) communicatively coupled to a UFS driver 204 (e.g., part of the control module 112 of FIG. 1). The UFS driver 204 includes a native file system 206 layer, for example, either an NTFS or an ext3 type file system layer. The masters 203a-n may include one or more applications being executed by the processors 102, 104, 106. The UFS driver 204 may be configured to receive memory commands and route each memory command to a command queue. Memory commands from an application generally relate to operations in memory such as input/output (I/O) operations (e.g., read and write operations).

A host controller 208 (e.g., part of the control module 112 of FIG. 1) includes a plurality of command queues 210a-n configured to temporarily store memory commands received from the UFS driver 204. It should be noted that the host controller 208 may also be referred to as a “storage controller” throughout the disclosure. In some examples, each of the plurality of command queues 210a-n is a buffer that can store up to 32 memory commands before the commands are transferred to the UFS memory device for execution. In certain aspects, each of the plurality of command queues 210a-n is a dedicated command queue corresponding to a specific storage buffer 212a-n on the UFS device 222. That is, in some examples, each command queue 210a-n may have a dedicated set of buffer resources on the UFS device 222. Similarly, each command queue 210a-n may be dedicated to one of the multiple masters 203a-n.

In certain aspects, each of the plurality of command queues 210a-n are communicatively coupled to one of a plurality of storage buffers 212a-n (e.g., part of the memory module 116 of FIG. 1) in the UFS device 222. In one example, the command queues 210a-n are communicatively coupled to the plurality of storage buffers 212a-n via one or more lanes. Each lane may include a high-speed serial interface configured for electrical transmission of data. In some examples, each lane is a bi-directional, single-signal, physical transmission channel. Accordingly each lane may be a standalone physical interface between a command queue (e.g., a first command queue 210a) and a storage buffer (e.g., a first storage buffer 212a). The rate at which data is transmitted over the plurality of lanes is dependent on which gear of a plurality of gears is being used. In some examples, each gear corresponds to a different data rate. Table 1 below provides an example of a plurality of gears and corresponding data rates:

TABLE 1

| | |
|---|---|
| Data Rate Per Lane (Gbps) | Gear |

| | | |
|---|---|---|
| 1.5 | Gbps | HS-G1 (first gear) |
| 3 | Gbps | HS-G2 (second gear) |
| 6 | Gbps | HS-G3 (third gear) |
| 11.7 | Gbps | HS-G4 (fourth gear) |

Host controller 208 is configured to select the gear and number of lanes that the UFS device 222 uses for each memory command according to one or more parameters, including the priority of the memory command. In one embodiment, the commands and signaling protocol are compatible with one or more standards, for example, with non-volatile memory express (NVMe) or the small computer system interface (SCSI) (in the case of commands) and peripheral component interconnect express (PCIe) or serial-attached SCSI/serial ATA (SAS/SATA) (in the case of signaling formats).

The plurality of storage buffers 212a-n are communicatively coupled to a flash memory 214. Flash memory 214 may include a non-volatile memory (NVM), such as a flash memory made up of one or more one or more dies or planes of flash memory cells (e.g., single level cells, multi-level cells, tri level cells, etc.). Flash memory 214 interfaces with the plurality of storage buffers 212a-n to receive memory commands from the host controller 208 for memory operations, including: read, write, copy, and reset (e.g., erase).

The host controller 208 may receive a large volume of memory commands in scenarios where multiple masters and/or applications are operating simultaneously. Moreover, certain operating parameters of the SoC 202, the masters 203a-n, and the command queues 210a-n may affect efficiency as the host controller 208 services the memory commands. Thus, methods for modulating how the host controller 208 manages memory commands based on one or more of the operating parameters would improve operation of the host controller 208 and the flash memory 214.

In some examples, the storage driver 204 may determine which command queues of the plurality of command queues 210a-n to use for serving a plurality of memory commands to the UFS device 222, based on one or more operating parameters. For example, the one or more parameters may include on one or more of a number of active masters, a number of active applications, a state of charge of a battery providing power to the host controller 208, and an average amount of time required for serving a memory command.

### Example Performance-Efficient Methods of Memory Command Management

In certain aspects, the UFS driver 204 and the host controller 208 may be configured to implement performance-efficient techniques for managing a plurality of memory commands. For example, the file system 206 may be configured to select one of a power-efficient mode or a performance-efficient technique for servicing a plurality of commands received by the UFS driver 204.

In certain aspects, the file system 206 may select and implement the performance-efficient mode for managing the plurality of memory commands based on system conditions. For examples, if a battery providing power to the host controller 208 and/or the UFS driver 204 is greater than a threshold level of charge (e.g., the battery has a charge that is greater than 20%) or if the SoC 202 is receiving power from a plug-in source. In certain aspects, the UFS driver 204 and the host controller 208 may select and implement a performance-efficient technique for managing the plurality of memory commands if the UFS driver 204 receives a relatively large number of memory commands. It should be noted that the performance-efficient technique for managing the plurality of memory commands may require the UFS driver 204 and the host controller 208 to consume more power relative to the power-efficient mode.

In the example illustrated in FIG. 2A, a first master 203a and a second master 203b each provide twenty memory commands to the UFS driver 204. In this example, the file system 206 may select a performance-efficient technique for serving the memory commands to the UFS memory 222, based on system conditions. Using the performance-efficient technique, the UFS driver 204 transfers all of the received memory commands to all of the plurality of command queues. It should be noted, in some examples, the UFS driver 204 may transfer all of the received memory commands to any suitable number of command queues, depending on a capacity of one or more of the command queues 210a-n in the host controller 208.

In one example, the file system 206 determines a number of command queues of the plurality of command queues 210a-n to use to service the plurality of memory commands to the UFS memory 222. The determination may be based, at least in part, on the capacity of one or more of the command queues 210a-n in the host controller 208. For example, the file system 206 may determine which of the number of command queues have a capacity to store at least one of the plurality of memory commands. As shown in FIG. 2A, the UFS driver 204 transfers all forty of the memory commands (e.g., the twenty memory commands from the first master 203a and the twenty memory commands from the second master 203b) to the host controller 208, routing the memory commands according to the determined number of command queues.

In this example, the forty memory commands are routed and distributed evenly among the first command queue 210a, the second command queue 210b, the third command queue 210c, and a fourth command queue 210n, such that each command queue receives ten memory commands from the forty memory commands received by the UFS driver 204. However, in other examples, the plurality of memory commands may be distributed according to a capacity of one or more of the command queues 210a-n. For example, the number of memory commands may be routed and distributed asymmetrically among the plurality of command queues according to the capacity of each of the plurality of command queues.

In certain aspects, the UFS driver 204 routes the plurality of memory commands to the command queues (e.g., 210a-n) via one or more of a plurality of lanes, wherein each of the plurality of lanes corresponds to one of the plurality of command queues. In some examples, each of the lanes is dedicated to a particular command queue.

In certain aspects, the host controller 208 receives the plurality of memory commands, and stores each command in a command queue according to the routing of the UFS driver 204. In this example, the host controller 208 receives forty commands, and each of the first command queue 210a, the second command queue 210b, the third command queue 210c, and the fourth command queue 210n store ten of the forty memory commands. The host controller 208 may then serve the forty memory commands to the UFS device 222.

### Example Power-Efficient Methods of Memory Command Management

FIG. 2B is block diagram illustrating the exemplary memory system 250 including an SoC 202 (e.g., SoC 100) and a UFS device 222 (e.g., memory module 116 of FIG. 1) in accordance with certain aspects of the present disclosure. In certain aspects, the UFS driver 204 and the host controller 208 may be configured to implement power-efficient techniques for managing a plurality of memory commands.

In certain aspects, the file system 206 may select and implement the power-efficient mode for managing the plurality of memory commands based on system conditions. For examples, if a battery providing power to the host controller 208 and/or the UFS driver 204 is less than a threshold level of charge (e.g., the battery has a charge that is less than 20%) or if the SoC 202 is receiving power from a plug-in source.

In the example illustrated in FIG. 2B, a first master 203a and a second master 203b each provide fifteen memory commands to the UFS driver 204. In this example, the file system 206 may select a power-efficient technique for serving the memory commands to the UFS memory 222, based on system conditions. Using the power-efficient technique, the UFS driver 204 transfers the received memory commands to the host controller 208 using a minimum number of command queues, while reducing power to one or more of the lanes and command queues not used for routing or storing a memory command. For example, if the power-efficient technique is selected, the file system 206 may determine whether a single command queue of the plurality of commands queues has a capacity to store the plurality of memory commands. If not, the file system 206 may determine whether a combination of a command queue having the greatest capacity and another command queue can store the plurality of memory commands.

For example, if a first command queue 210a has the capacity to store the plurality of memory commands, the UFS driver 204 may route, via a first lane corresponding to the first commands queue 210a, the plurality of memory commands to the first command queue 210a. However, if the first command queue 210a does not have the capacity to store the plurality of memory commands, the UFS driver 204 may route, via the first lane, a first portion of the plurality of memory commands to the first command queue 210a such that the capacity of the first command queue 210a is filled, and route, via a second lane, a second portion of the plurality of memory commands to a second command queue 210b.

In one example, the file system 206 determines a number of command queues of the plurality of command queues 210a-n to use to service the plurality of memory commands to the UFS memory 222. The determination may be based, at least in part, on the capacity of one or more of the command queues 210a-n in the host controller 208. For example, the file system 206 may determine which of the number of command queues have a capacity to store at least one of the plurality of memory commands. As shown in FIG. 2A, the UFS driver 204 transfers all thirty of the memory commands (e.g., the twenty memory commands from the first master 203a and the twenty memory commands from the second master 203b) to the host controller 208, routing the memory commands according to the determined number of command queues.

In this example, the UFS driver 204 routes the thirty memory commands (e.g., fifteen memory commands from the first master 203a, and fifteen memory commands from the second master 203b) to the first command queue 210a such that the first command queue 210a receives all thirty of the memory commands received by the UFS driver 204. In this example, the first command queue 210a has a capacity (or queue depth) of 32, meaning that the first command queue 210a may store 32 memory commands. Here, the SoC 202 is able to reduce power to the other command queues (e.g., a second command queue 210b, a third command queue 210c, and a fourth command queue 210n), to lanes between the UFS driver 204, and lanes between the host controller 208 and the UFS device 222.

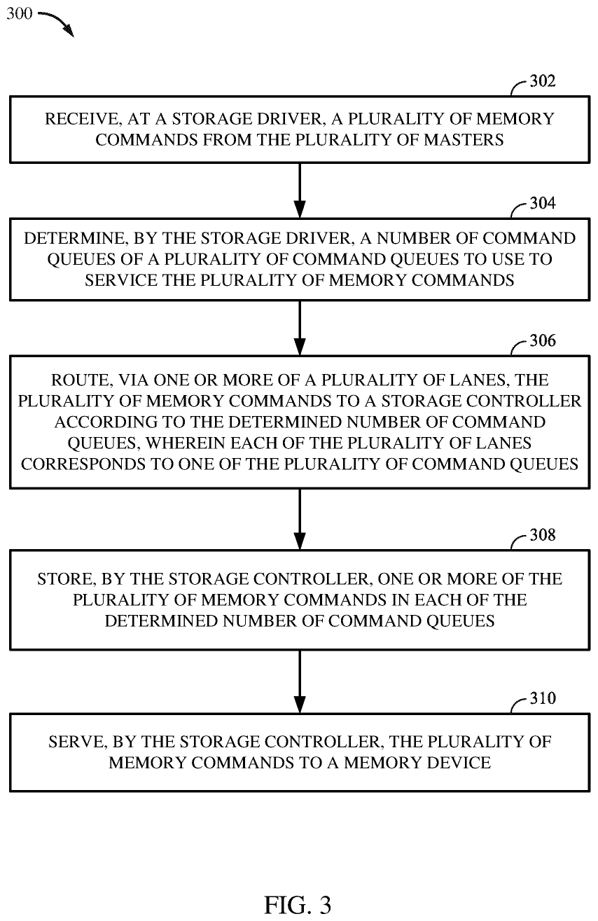

FIG. 3 is a flow chart illustrating example operations 300 for managing a host controller command queue. The operations 300 may be performed, for example, by a UFS driver and a host controller (e.g., such as the UFS driver 204 and the host controller 208 of FIGS. 2A and 2B). Operations 300 may be implemented as software components that are executed and run on one or more processors (e.g., processing system 120 of FIG. 1). In certain aspects, the transmission and/or reception of data by various hardware components may be implemented via a bus interface (e.g., bus module 110 of FIG. 1).

In this example, the operations 300 start at a first step 302 by receiving, at a storage driver, a plurality of memory commands from the plurality of masters.

The operations 300 then proceed to step 304, by determining, by the storage driver, a number of command queues of a plurality of command queues to use to service the plurality of memory commands.

The operations 300 then proceed to step 306, by routing, via one or more of a plurality of lanes, the plurality of memory commands to a storage controller according to the determined number of command queues, wherein each of the plurality of lanes corresponds to one of the plurality of command queues.

The operations 300 then proceed to step 308, by storing, by the storage controller, one or more of the plurality of memory commands in each of the determined number of command queues.

The operations 300 then proceed to 310, serving, by the storage controller, the plurality of memory commands to a memory device.

In certain aspects, the operations 300 include determining the number of command queues to use to service the plurality of memory commands further comprises selecting one of a power-efficient mode and a performance-efficient mode for servicing the plurality of commands.

In certain aspects, if the power-efficient mode is selected, determining the number of command queues further comprises determining whether a first command queue of the plurality of commands queues has a capacity to store the plurality of memory commands.

In certain aspects, routing the plurality of memory commands further comprises: if the first command queue has the capacity to store the plurality of memory commands, routing, via a first lane corresponding to the first commands queue, the plurality of memory commands to the first command queue. If the first command queue does not have the capacity to store the plurality of memory commands, routing, via the first lane, a first portion of the plurality of memory commands to the first command queue such that the capacity of the first command queue is filled, and routing, via a second lane, a second portion of the plurality of memory commands to a second command queue.

In certain aspects, the operations 300 further comprise reducing power to one or more of the plurality of lanes not used for routing the plurality of memory commands.

In certain aspects, if the performance-efficient mode is selected, the operations 300 include determining one or more command queues of the plurality of command queues having a capacity to store at least one of the plurality of memory commands.

In certain aspects, routing the plurality of memory commands further comprises routing, via one or more lanes, the plurality of memory commands to the plurality of command queues such that the plurality of memory commands are distributed among the one or more command queues having the capacity to store at least one of the plurality of memory commands.

In certain aspects, wherein selecting one of the power-efficient mode and the performance-efficient mode is based on one or more of: a number of active masters, a number of active applications, a state of charge of a battery providing power to the storage controller, or an average amount of time used for serving a memory command.

In certain aspects, wherein each of the plurality of command queues is associated with one of a plurality of storage buffers in the memory device.

### Additional Considerations

In some configurations, the term(s) ‘communicate,’ ‘communicating,’ and/or ‘communication’ may refer to ‘receive,’ ‘receiving,’ ‘reception,’ and/or other related or suitable aspects without necessarily deviating from the scope of the present disclosure. In some configurations, the term(s) ‘communicate,’ ‘communicating,’ ‘communication,’ may refer to ‘transmit,’ ‘transmitting,’ ‘transmission,’ and/or other related or suitable aspects without necessarily deviating from the scope of the present disclosure.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits.

One or more of the components, steps, features and/or functions illustrated herein may be rearranged and/or combined into a single component, step, feature or function or embodied in several components, steps, or functions. Additional elements, components, steps, and/or functions may also be added without departing from novel features disclosed herein. The apparatus, devices, and/or components illustrated herein may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for” or simply as a “block” illustrated in a figure.

These apparatus and methods described in the detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, firmware, routines, subroutines, objects, executables, threads of execution, procedures, functions, etc., whether referred to as software, firmware, middleware, microcode, hardware description language, or otherwise. The software may be stored on non-transitory computer-readable medium included in the processing system.

Accordingly, in one or more exemplary embodiments, the functions described may be implemented in hardware, software, or combinations thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, PCM (phase change memory), flash memory, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

What is claimed is:

1. A method for managing memory commands from a plurality of masters, comprising:
receiving, at a storage driver, a plurality of memory commands from the plurality of masters;
determining, by the storage driver, a number of command queues of a plurality of command queues to use to service the plurality of memory commands;
routing, via one or more of a plurality of lanes, the plurality of memory commands to a storage controller according to the determined number of command queues, wherein each of the plurality of lanes corresponds to one of the plurality of command queues;
storing, by the storage controller, one or more of the plurality of memory commands in each of the determined number of command queues; and
serving, by the storage controller, the plurality of memory commands to a memory device.

2. The method of claim 1, wherein determining the number of command queues to use to service the plurality of memory commands further comprises selecting one of a power-efficient mode and a performance-efficient mode for servicing the plurality of commands.

3. The method of claim 2, wherein, if the power-efficient mode is selected, determining the number of command queues further comprises determining whether a first command queue of the plurality of commands queues has a capacity to store the plurality of memory commands.

4. The method of claim 3, wherein routing the plurality of memory commands further comprises:
if the first command queue has the capacity to store the plurality of memory commands, routing, via a first lane corresponding to the first commands queue, the plurality of memory commands to the first command queue;
if the first command queue does not have the capacity to store the plurality of memory commands:
routing, via the first lane, a first portion of the plurality of memory commands to the first command queue such that the capacity of the first command queue is filled, and
routing, via a second lane, a second portion of the plurality of memory commands to a second command queue.

5. The method of claim 4, further comprising reducing power to one or more of the plurality of lanes not used for routing the plurality of memory commands.

6. The method of claim 2, wherein, if the performance-efficient mode is selected, determining one or more command queues of the plurality of command queues having a capacity to store at least one of the plurality of memory commands.

7. The method of claim 5, wherein routing the plurality of memory commands further comprises routing, via one or more lanes, the plurality of memory commands to the plurality of command queues such that the plurality of memory commands are distributed among the one or more command queues having the capacity to store at least one of the plurality of memory commands.

8. The method of claim 2, wherein selecting one of the power-efficient mode and the performance-efficient mode is based on one or more of:
a number of active masters;
a number of active applications;
a state of charge of a battery providing power to the storage controller; or
an average amount of time used for serving a memory command.

9. The method of claim 1, wherein each of the plurality of command queues is associated with one of a plurality of storage buffers in the memory device.

10. An apparatus configured to manage memory commands from a plurality of masters, comprising:
a memory; and
a processor communicatively coupled to the memory, wherein the processor is configured to:
determine, by a storage driver, a number of command queues of a plurality of command queues to use to service the plurality of memory commands;
route, via one or more of a plurality of lanes, the plurality of memory commands to a storage controller according to the determined number of command queues, wherein each of the plurality of lanes corresponds to one of the plurality of command queues;
store, by the storage controller, one or more of the plurality of memory commands in each of the determined number of command queues; and
serve, by the storage controller, the plurality of memory commands to a memory device.

11. The apparatus of claim 10, wherein the processor, being configured to determine the number of command queues to use to service the plurality of memory commands, is further configured to select one of a power-efficient mode and a performance-efficient mode for servicing the plurality of commands.

12. The apparatus of claim 11, wherein, if the power-efficient mode is selected, the processor, being configured to determine the number of command queues, is further configured to determine whether a first command queue of the plurality of commands queues has a capacity to store the plurality of memory commands.

13. The apparatus of claim 12, wherein the processor, being configured to route the plurality of memory commands, is further configured to:
route, via a first lane corresponding to the first commands queue, the plurality of memory commands to the first command queue if the first command queue has the capacity to store the plurality of memory commands.

14. The apparatus of claim 13, wherein the processor, being configured to route the plurality of memory commands, is further configured to:
route, via the first lane, a first portion of the plurality of memory commands to the first command queue such that the capacity of the first command queue is filled; and
route, via a second lane, a second portion of the plurality of memory commands to a second command queue if the first command queue does not have the capacity to store the plurality of memory commands.

15. The apparatus of claim 14, wherein the processor is further configured to reduce power to one or more of the plurality of lanes not used for routing the plurality of memory commands.

16. The apparatus of claim 11, wherein, if the performance-efficient mode is selected, the processor is further configured to determine one or more command queues of the plurality of command queues having a capacity to store at least one of the plurality of memory commands.

17. The apparatus of claim 15, wherein the processor, being configured to route the plurality of memory commands, is further configured to route, via one or more lanes, the plurality of memory commands to the plurality of command queues such that the plurality of memory commands are distributed among the one or more command queues having the capacity to store at least one of the plurality of memory commands.

18. The apparatus of claim 11, wherein selecting one of the power-efficient mode and the performance-efficient mode is based on one or more of:
a number of active masters;
a number of active applications;
a state of charge of a battery providing power to the storage controller; or
an average amount of time used for serving a memory command.

19. The apparatus of claim 10, wherein each of the plurality of command queues is associated with one of a plurality of storage buffers in the memory device.

20. A non-transitory computer readable storage medium that stores instructions that when executed by a processor of an apparatus cause the apparatus to perform a method of manage memory commands from a plurality of masters, comprising:
receiving, at a storage driver, a plurality of memory commands from the plurality of masters;
determining, by the storage driver, a number of command queues of a plurality of command queues to use to service the plurality of memory commands;
routing, via one or more of a plurality of lanes, the plurality of memory commands to a storage controller according to the determined number of command queues, wherein each of the plurality of lanes corresponds to one of the plurality of command queues;
storing, by the storage controller, one or more of the plurality of memory commands in each of the determined number of command queues; and
serving, by the storage controller, the plurality of memory commands to a memory device.
